(19) United States
(12) Patent Application Publication
(10) Pub. No.: US 2014/0121021 A1
(43) Pub. Date: May 1, 2014

(54) METHOD AND SYSTEM FOR VIDEO GAMING USING INPUT ADAPTATION FOR MULTIPLE INPUT DEVICES

(71) Applicants: NISHITH SHAH, PUNE (IN); HARDIK BELANI, PUNE (IN); VIMALESH KAMAT, PUNE (IN); RAVIPRASHANT YADAV, PUNE (IN)

(72) Inventors: NISHITH SHAH, PUNE (IN); HARDIK BELANI, PUNE (IN); VIMALESH KAMAT, PUNE (IN); RAVIPRASHANT YADAV, PUNE (IN)

(21) Appl. No.: 13/751,150

(22) Filed: Jan. 28, 2013

(30) Foreign Application Priority Data
Oct. 29, 2012 (IN) 3111/MUM/2012
Oct. 29, 2012 (IN) 3112/MUM/2012
Oct. 29, 2012 (IN) 3113/MUM/2012

(51) Int. Cl. A63F 13/06

(52) U.S. Cl. CPC A63F 13/06
USPC 463/38; 463/43; 463/37

(57) ABSTRACT

Computer system to facilitate video gaming comprising a processing unit and a computer readable medium coupled to the processing unit comprising instructions executable by the processing unit. Instructions are for a video game to process first input triggered by operation of multiple input devices. Instructions are for input adaptation module to facilitate playing the same video game using an input device such as the game controller that is free from facility to provide the first input using the multiple input devices. The input adaptation module receives second input triggered by operation of the input device such as the game controller used to navigate the game. It generates the first input from the second input, based at least upon a translation mapping between input events receivable from the input device such as the game controller and input events receivable from the multiple input devices. Associated method is also provided.

### CROSS-REFERENCE TO RELATED APPLICATIONS

The present application claims priority to the following three Indian Patent Applications, each of which is incorporated by reference herein: Indian Patent Application No. 3113/MUM/2012, entitled “Method and System for Video Gaming Using Game-Specific Input Adaptation”, filed Oct. 29, 2012; Indian Patent Application No. 3112/MUM/2012, entitled “Method and System for Video Gaming Using Touchscreen Input Adaptation”, filed Oct. 29, 2012; and Indian Patent Application No. 3111/MUM/2012, entitled “Method and System for Video Gaming Using Input Adaptation for Multiple Input Devices”, filed Oct. 29, 2012. The present application is related to the following two US Patent Applications filed on the same day, each of which is incorporated by reference herein: U.S. patent application No. ______, entitled “Method and System for Video Gaming Using Touchscreen Input Adaptation” to inventors Nishith Shah, Hardik Belani and Vimalesh Kamat, and U.S. patent application No. ______, entitled “Method and System for Video Gaming Using Game-Specific Input Adaptation” to Nishith Shah, Hardik Belani, Samir Patel, Vimalesh Kamat and Raviprashant Yaday.

### BACKGROUND OF THE INVENTION

Video gaming over television has been popular. Such video gaming is typically facilitated using a game console connected to the television display. The game console is typically a computer system that runs the game software and produces audio and video signal for the display device such as the television. The video game player typically uses an input device, such as a game controller, a gamepad, or a remote control, that is connected to the game console to navigate the game and the game menus. The game console also often includes facility for connection to a computer network such as the Internet. Video gaming systems such as Xbox provided by Microsoft Corporation and PlayStation provided by Sony Corporation have been popular. Some game consoles such as Wii provided by Nintendo also offer the ability to play games using motion input.

An exemplary schematic of typical video gaming system 100 including a television (101), a game console (102), and a game controller (103) is illustrated in FIG. 1. These types of video gaming systems are popular for gaming at home, hotel rooms, etc. The game controller input interface typically includes controls such as joystick, direction keys, action buttons, etc. An exemplary schematic of a game controller (103) is shown in FIG. 2. This diagram is merely example. Alternative game controller designs are possible in which the controls can be positioned differently, one or more controls can be omitted, additional controls can be added, etc. As shown in FIG. 2, the game controller can include a left joystick (201), a right joystick (202), direction keys (203), action buttons (204), and shoulder keys (205, 206). Action buttons are often colored red, green, yellow, blue etc. Alternatively or in addition, they can also have markings on them such as “X”, “Y”, “A”, “B”, etc. The game controller (103) can communicate with the game console (102) using wired connection or using wireless connection such as Bluetooth, Wi-Fi, etc.

Today's game consoles are technologically advanced computer systems. They support rich gaming environment and facilitate high definition (HD) quality gaming on the television. These specialized gaming consoles are relatively expensive. Moreover, developing games for these game consoles requires specialized skills. Game development requires technical sophistication on part of the developer, it is time consuming, and may also require specialized hardware and/or software development platforms appropriate for the specific game consoles. This has caused the cost of game development to rise thereby driving up the retail cost of the games themselves. As merely an example, the game “Gran Turismo 5” cost $60 Million to develop as reported at http://www.develop-online.net/news/33204/Gran-Turismo-5-budget-put-at-60m. Today, typical retail price for the Xbox or the PlayStation game can be $30-$60 and for the Wii game can be $15-$30.

The present invention provides novel techniques for video gaming which can alleviate certain shortcomings of the current video gaming systems.

### SUMMARY OF THE INVENTION

An object of the present invention is to provide for video gaming system such as illustrated in FIG. 1, at lower cost compared to the state of the art. Another object of the present invention is to enhance user experience of playing certain pre-existing video games that are available on the mobile devices such as smartphones and tablets by enabling them on the console-based video gaming system such as illustrated in FIG. 1, which can have much larger display in the form of a television. Yet another object of the present invention is to enhance end user experience of playing certain pre-existing video games developed for mobile devices such as smartphones and tablets by enabling player input from input device such as the game controller that can sometimes be easier to operate (e.g., joystick operation on the game controller) compared to touch and tilt based inputs on the mobile devices.

In order to achieve the above mentioned and other objectives, the present invention contemplates using a readily available computer system such as a computer system running Android operating system as the game console. The present invention further contemplates re-purposing a number of inexpensive games already developed for mobile devices such as smartphones and tablets for the video gaming system such as illustrated in FIG. 1. As merely an example, a typical Android game for mobile devices can cost merely in the range $0 to $5. Notably, many popular Android games such as Temple Run, Angry Birds, iFigher, Death Worm, etc. that are developed for Android smartphones and tablets are available at no cost for downloading from the Google Play website. There are several others which are available for purchase for merely $0.99, $1.99, etc. Moreover, enabling the games developed for mobile devices on the video gaming system such as illustrated in FIG. 1 results into superior end user experience due to ease of maneuverability of input device such as game controller and/or due to large sized television display. As merely an example, games which require fast reaction (e.g., avoiding enemy planes and their firings in Android iFighter 1945 game) are much more fun to play on large size display with game controller, compared to touchscreen and soft buttons or accelerometer of mobile devices.

A practical challenge encountered in such approach is that many exciting games developed for mobile devices require input devices such as touchscreen and accelerometer that are often found in smartphones and tablets for the player to be able to navigate the game. Often, the games also require use of multiple input devices concurrently to navigate the video game. Input device such as the game controller in the video gaming system typically lacks these input facilities. Moreover, such game applications are incapable of processing input events generated by the input device such as the game controller, at least in certain configurations. Also notably, different video games require different combinations of input devices such as touchscreen and accelerometer to be able to navigate the game. Moreover, the semantics of the input from different input devices differ for different games.

The present invention provides novel system and method to enable mobile devices based video games in the video gaming system such as illustrated in FIG. 1, including a way to perform input events translation from the input device such as the game controller, the game pad, the remote control, etc. to those required by the video game application. In an embodiment, the system and method of the present invention contemplates performing events translation from a single input device used to navigate the game such as a game controller to events understood by the video game application that can be generated by a plurality of input devices such as a touchscreen and an accelerometer. In an alternative embodiment, the system and method of the present invention include a way to automatically select and use the events translation that is appropriate for the game being played. Notably, the techniques according to the present invention can readily work with pre-existing mobile devices based gaming applications, thereby unlocking a treasure chest of inexpensive and exciting mobile devices based video games for the player of the video gaming system.

According to a specific embodiment of the present invention, a computer system is provided. The computer system is coupled to a display device and a game controller. It includes a way to facilitate video gaming. The computer system comprises a processing unit. It also includes a computer readable medium coupled to the processing unit. The computer readable medium comprises a first set of instructions for a video game executable by the processing unit to perform the steps of receiving a first input for navigating the video game from a game player, performing game-logic computation for the video game based at least upon the first input, and generating the video game output based at least upon the performing the game-logic computation. The first input is to be provided via operating multiple input devices including a first input device and a second input device. The first input comprises a first plurality of input events triggered via operation of the first input device and a second plurality of input events triggered via operation of the second input device. Moreover, the computer readable medium comprises a second set of instructions for input adaptation module to facilitate playing the same video game using a third input device that is free from facility to provide the first input using the first input device and the second input device. For example, the third input device can be a game controller including one or more joysticks and one or more buttons. The second set of instructions are executable by the processing unit to perform the step of receiving a second input from a game player provided using the third input device, wherein the second input comprises a third plurality of input events triggered via operation of a first control on the third input device and a fourth plurality of input events triggered via operation of a second control on the third input device. The second set of instructions are also executable by the processing unit to perform the step of generating the first plurality of the input events from the third plurality of the input events, based at least upon a first predetermined mapping that translates events triggered by operation of the first control on the third input device to events triggered by operation of the first input device. Moreover, the second set of instructions are executable by the processing unit to perform the step of generating the second plurality of the input events from the fourth plurality of the input events, based at least upon a second predetermined mapping that translates events triggered by operation of the second control on the third input device to events triggered by operation of the second input device. Associated method is also provided.

These and various other objects, features and advantages of the present invention can be more fully appreciated with reference to the detailed description and accompanying drawings that follow.

### BRIEF DESCRIPTION OF THE DRAWINGS

FIG. 1 illustrates an exemplary schematic of a video gaming system comprising a television, a game console and a game controller.

FIG. 2 illustrates an exemplary schematic of a game controller.

FIG. 3 illustrates an exemplary schematic of a readily available computer system capable of hosting Android operating system environment according to a specific embodiment of the present invention.

FIG. 4 illustrates an exemplary schematic of a typical Android operating system environment that is appropriate for hosting a video game application and an input adaptation module according to a specific embodiment of the present invention.

FIG. 5 illustrates certain exemplary mappings that describe translation from game controller events to input events understood by different video games according to a specific embodiment of the present invention.

FIG. 6 illustrates an exemplary flowchart in a method for input adaptation according to a specific embodiment of the present invention.

FIG. 7A and FIG. 7B illustrate exemplary schematics of providing touch and swipe input using a game controller with the help of a visual indicator according to a specific embodiment of the present invention.

FIG. 8 illustrates an exemplary schematic of input adaptation from a game controller to a plurality of input devices required to navigate the video game.

### DETAILED DESCRIPTION OF THE INVENTION

Throughout the specification, specific embodiments of the present invention are described with the aid of references to specific figures, examples, and environments. This facilitates thorough disclosure of the invention. It is to be noted that these specific embodiments are illustrative rather than limiting. Based on these teachings, person of ordinary skill in the art can contemplate various alternatives, variations and modifications to the illustrated embodiments within the scope of the invention disclosed herein.

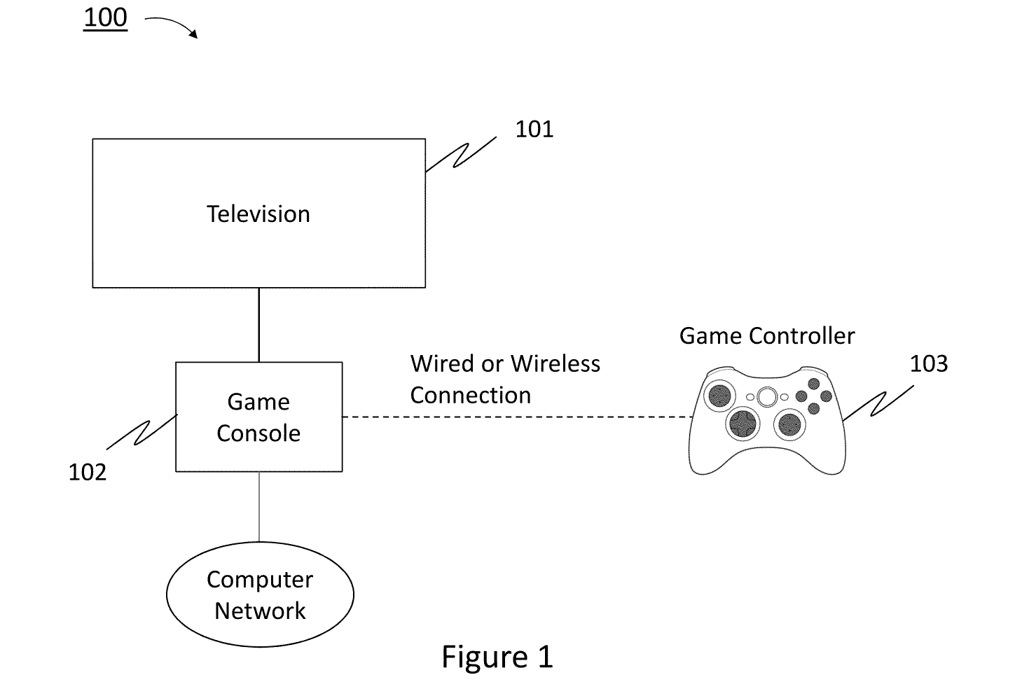

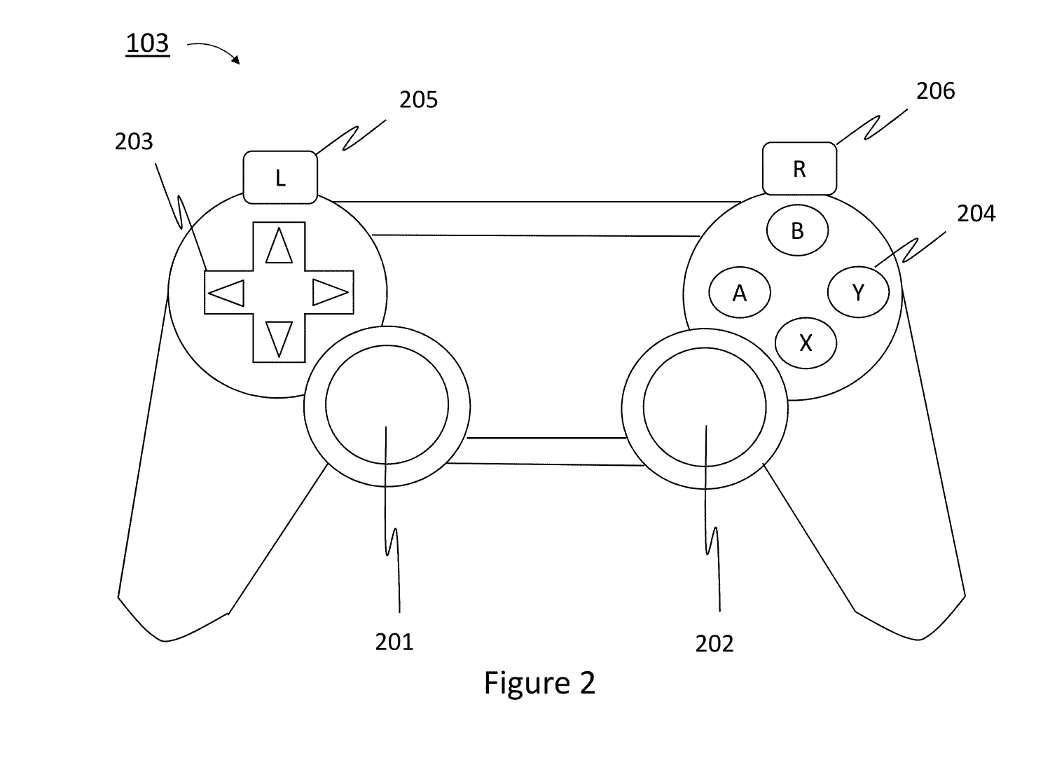

As previously stated, the present invention contemplates deploying video games originally developed for mobile devices such as smartphones and tablets to the video gaming system such as illustrated in FIG. 1. This facilitates lowering retail cost of video games. As merely an example, a typical Android game for mobile devices costs $0-$5 compared to $30-$60 for Xbox/PlayStation game. Moreover, the video gaming system such as illustrated in FIG. 1 can provide richer player experience due to large size display of television and ease of maneuverability of the input device such as the game controller compared to the mobile device. The present invention also contemplates making pre-existing mobile devices based video game applications readily available on the video gaming system such as in FIG. 1. That is, it is not necessary to make changes to the video game application itself. This results into large selection of inexpensive and exciting mobile devices based video games being readily available for the video gaming system. To achieve these and other objectives, the present invention provides novel techniques that are described below in greater detail.

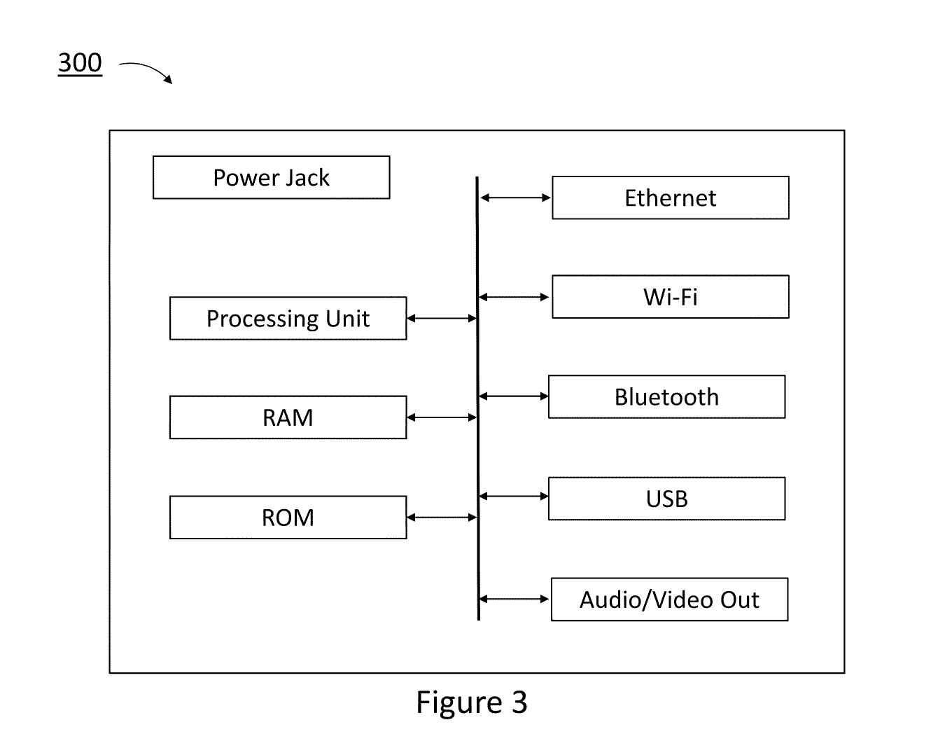

In a specific embodiment according to the present invention, the game console (102) is provided using readily available operating system (OS) running on readily available hardware. As merely an example, the readily available hardware can include Internet television (IP TV) set-top-box device. An IP TV set-top-box device typically includes a central processing unit (provided using microprocessor/microcontroller from Amlogic, Renesas, Nvidia, etc.), a wired network interface such as Ethernet, wireless network interfaces such as Wi-Fi and Bluetooth, volatile memory (RAM), persistent memory (flash ROM), power jack, audio/video output (HDMI, component video, s-video, composite video, audio, etc.), and USB. An exemplary schematic of a game console (300) provided using IP TV set-top-box device according to a specific embodiment of the present invention is illustrated in FIG. 3. This diagram is merely example. Alternative devices are possible in which one or more components can be omitted, additional components can be added, components can be rearranged, etc. Also, while the IP TV set-top-box device is described in the specific embodiments, other appropriate hardware platforms can also be used to provide the game console.

Moreover, in a specific embodiment of the present invention, the game console (300) runs Android operating system (OS) provided by Google Inc. Android is an open source OS that is often provided on mobile devices such as smartphones and tablets. Android OS environment typically includes kernel, middleware, and applications. Android game development does not necessarily require proprietary and/or expensive development platform. Moreover, proliferation of mobile devices has resulted into large number of inexpensive and rich video games already developed for Android based mobile devices. Thus, using Android for the game console facilitates deploying video games developed for Android based mobile devices on the game console. Moreover, the present invention provides techniques due to which no modification is required to these mobile devices based game applications in order to run them on the game console with the game controller.

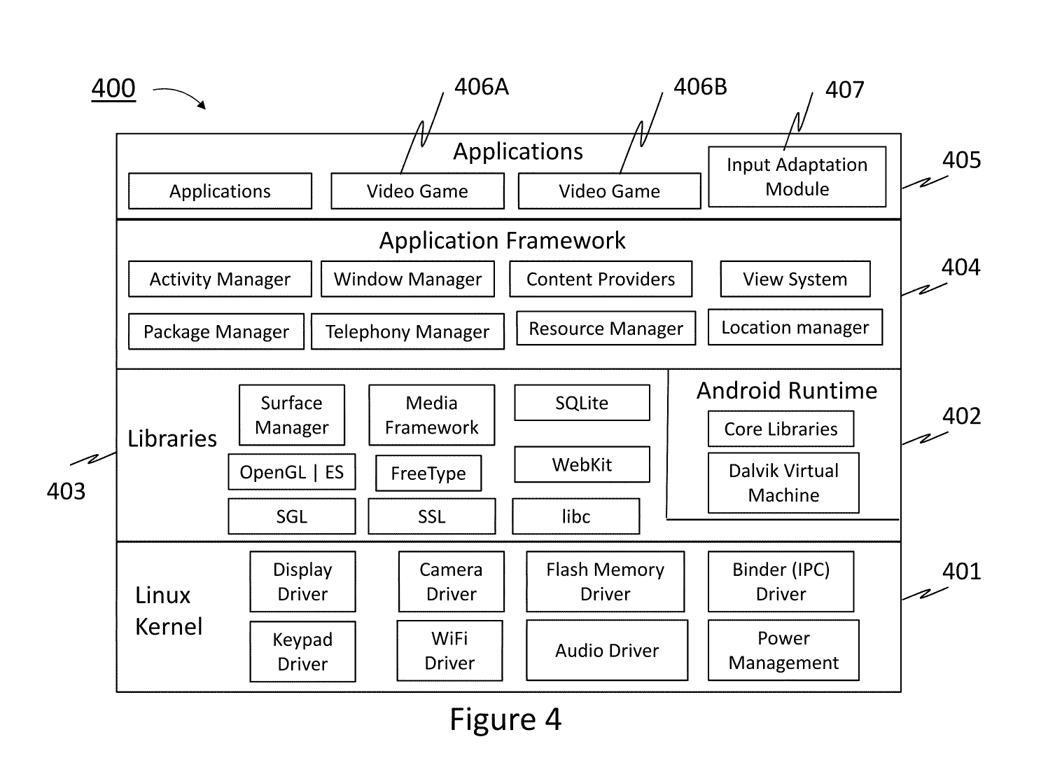

An exemplary schematic of a typical Android OS environment (400) is illustrated in FIG. 4. As shown, it includes components such as Linux based kernel (401) which acts as abstraction layer over the hardware, Dalvik virtual machine based runtime environment which runs Android applications as separate processes (402), developer libraries (403) which facilitate programming Android applications, application framework (404) and applications (405). It is to be noted that though Android OS environment is described in the specific embodiments of the present invention, the present invention can also be used with other appropriate OS environments.

According to a specific embodiment of the present invention, the games developed for mobile devices such as smartphones and tablets are run in the game console (300) as applications (406A, 406B, etc.). However, a practical challenge that is encountered in such approach is that the games developed for mobile devices require input devices such as touchscreen and accelerometer that are often found in smartphones and tablets for the player to be able to navigate the game. The input device such as the game controller in the video gaming system typically lacks these input facilities. Moreover, such games developed for the mobile devices are typically incapable of processing input events generated by the input device such as the game controller. Also notably, different video games require different types of inputs from devices such as touchscreen and accelerometer. To overcome these challenges, the present invention provides input adaptation module (407) as an Android application in a specific embodiment. In a specific embodiment, this module provides for translation of the game controller input events (such as joystick, arrow buttons, action buttons, etc.) to the input events (such as touch, swipe, tilt, etc.) that are understood by the game applications (406A, 406B). Moreover, the input adaptation module can dynamically change the translation mapping based upon the identity of the game that the player chooses to play. The module (407) is capable of obtaining the events translation mapping for a selected game from a local data store on the game console or from a server computer in the computer network such as Internet. Additional details on the input adaptation module are provided below. In an alternative embodiment, the input adaptation module can also be provided as a module in the application framework (404).

Notably, many games developed for mobile devices require input from the player provided using devices such as touchscreen and accelerometer. Touchscreen on the mobile device can generate “touch event” when the player touches a location on the screen. The touch event typically includes co-ordinates of the point of touch. In a specific embodiment, touching action on a touchscreen can generate touch-down event when the touch is performed and touch-up event when the touch is released. The video game application can interpret touch-down event as touch event. Touchscreen can also generate “swipe event” when the player swipes on the screen. The swipe event is typically associated with a sequence of touch events, namely, touch-down event at the point where swipe is started, one or more touch-move events as the swipe is performed along some path, and touch-up event at the point where touch is released. Based upon such a sequence of touch related events, the game application can interpret a swipe gesture. The accelerometer in the mobile device generates “tilt event” when the device is tilted by the player. The tilt event typically describes extent of the tilt (e.g., in angular units such as degrees) with respect to one or more of X, Y and Z axes. On the other hand, operation of the game controller (103) generates events such a “joystick event” and “button event”. The joystick event identifies which joystick (e.g., left joystick, right joystick, etc.) is pressed by what amount (e.g., between zero and certain maximum value), while the button event identifies the type of button and whether it is pressed or released. According to a specific embodiment of the present invention, the input adaptation module (407) translates events from the game controller events to touch, swipe and tilt events, depending upon requirement of the video game. Several exemplary events translation mappings are illustrated in the following examples. In a specific embodiment, the translation mappings can be stored in XML (extensible markup language) file format, though other formats are possible.

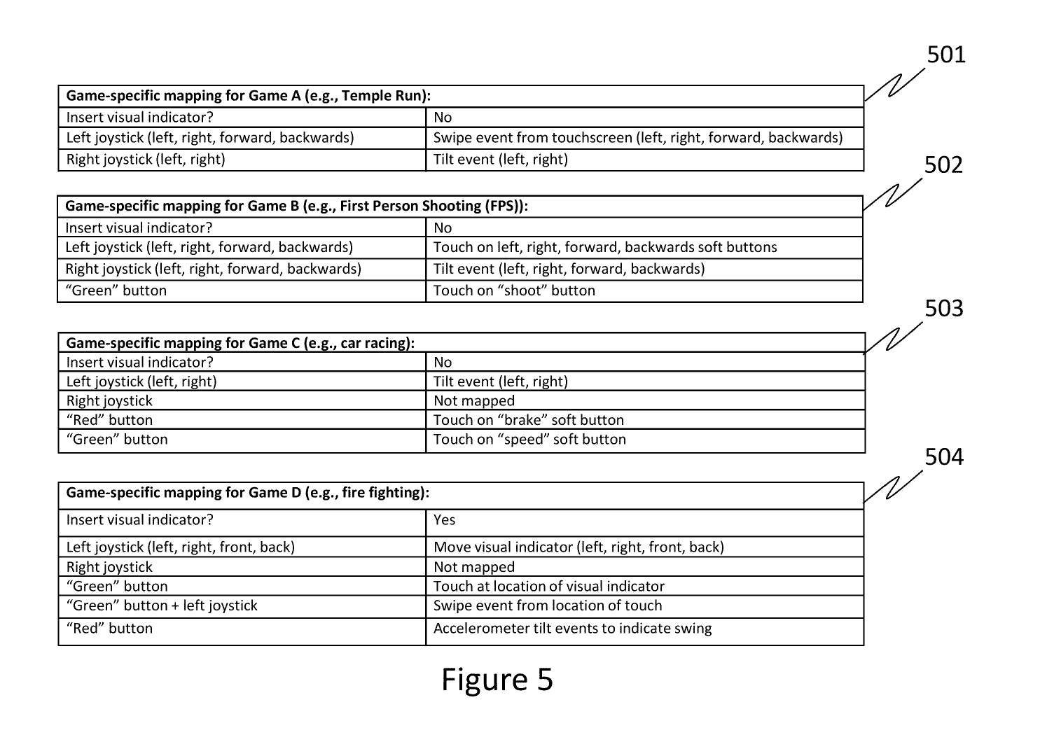

Game A:
Suppose this video game (e.g., popular Android game called “Temple Run”) processes following input events from touchscreen and accelerometer:
Touchscreen: Swiping left, right, forward, backwards anywhere on the touchscreen showing the game display makes the game character turn left, turn right, jump and slide under, respectively.
Accelerometer: Tilting the device towards left and right makes the game character pick up coins on the left and right hand sides of the path, respectively.
In order to play this video game using the game controller, exemplary events translation (501, illustrated in FIG. 5) can be:
Left joystick pushed to left, right, forward and backwards can translate to the swipe events required by the video game to make the character turn left, turn right, jump and slide under, respectively. In a specific embodiment, left joystick event from the game controller is mapped to a sequence of touch related events that characterize a swipe. For example, left joystick event can translate to touch-down event, touch-move event, and touch-up event. In certain games, the exact point where swipe is started and the exact path of the swipe is not important to properly navigate the video game. For such games, one or more of the touch-down event, the touch-move event and the touch-up event that are generated responsive to the joystick event can contain certain predetermined values for touch locations as long as the resulting swipe indicates the correct direction of the swipe. These predetermined values may be included in the translation mapping information. For example, in the Temple Run game, it may suffice to merely know direction of swipe. Thus for this game, left joystick pushed to left generates corresponding game controller event, which can be mapped to a touch-down event at a predetermined X-Y location, touch-move event along a predetermined path going leftwards from the touch-down event, and a touch-up event at a predetermined X-Y location.
Right joystick pushed to the left and right can translate to the left and right tilt events, respectively, to pick up the coins.

### Game B:

Suppose this video game (e.g., first person shooting (FPS) game) requires following input events from touchscreen and accelerometer:
Touchscreen: Touching the soft buttons displayed on the touchscreen showing four directions moves the shooter in corresponding directions.
Accelerometer: Tilting the device left, right, forward and backward changes the vision of the shooter to left, right, forward and backwards.
Additionally, touching the “shoot” soft button displayed on the touchscreen fires from the gun. In order to play this video game using the game controller, exemplary events translation (502, illustrated in FIG. 5) can be:
Left joystick pushed to left, right, forward and backwards can translate to the soft button touch events that are processed by the video game to move the shooter. Notice enrichment of player experience as maneuvering joystick to move the character is much easier than touching four soft buttons.
Right joystick pushed to left, right, forward and backward can translate to corresponding tilt events (tilt left, right, forward and backwards) to change the vision of the shooter. Again notice enrichment of player experience as maneuvering joystick to lock in different directions is much easier than tilting the device in that direction which also undesirably but inevitably causes game display to tilt. In certain games, the extent of the tilt is important to navigate the game. For example, in certain FPS game, the extent of the tilt may result into the character's vision turning by the corresponding extent in that direction. For such games, the tilt event that is generated responsive to the right joystick event needs to indicate the extent of the tilt. As a result, the extent by which the joystick is pushed as indicated in the joystick event generated from the game controller needs to be mapped to the extent of the tilt parameter in the tilt event. For example, the maximum range of the joystick's leftward motion needs to be mapped to maximum range of the tilt in the leftward direction (e.g., 0 to 180 degrees). Notably, the game may only process a subset of this entire range, e.g., 0 to 90 degrees.
Pressing the “green” button on the game controller can translate to the touch event that fires from the gun.

Game C:
Suppose this video game (e.g., car racing game) requires following inputs from touchscreen and accelerometer:
Touchscreen: Touch “brake” and “speed” soft buttons displayed on the touchscreen to brake and accelerate, respectively.
Accelerometer: Tilt the device left and right to turn the car left and right, respectively.
In order to play this video game using the game controller, exemplary events translation (503, illustrated in FIG. 5) would be:
Left joystick pushed to left and right can correspond to the left and right tilts, respectively, to turn the car.
Right joystick does not map to any action.
The “red” button on the game controller maps to braking action and the “green” button maps to accelerating action.

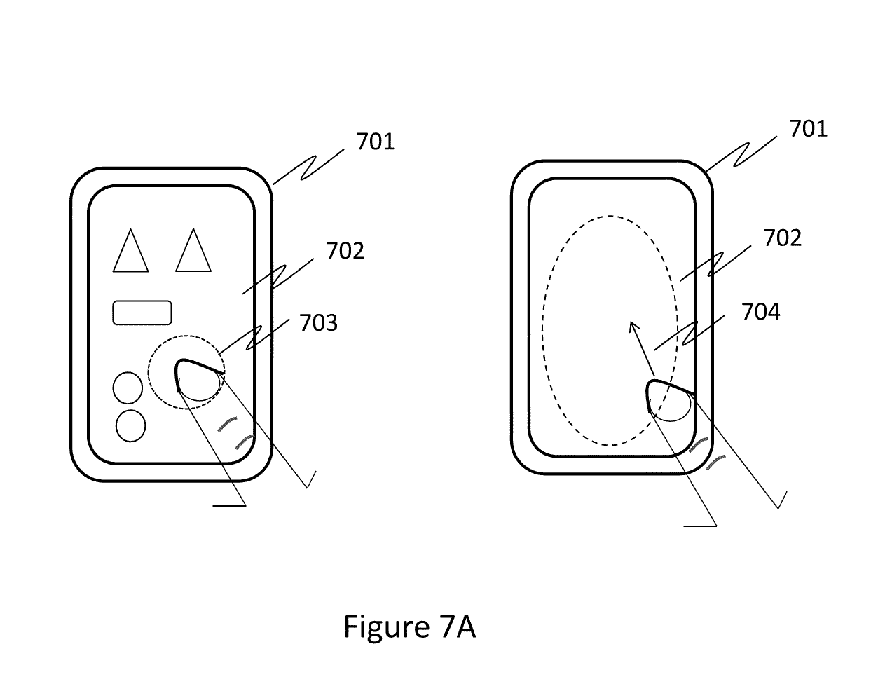

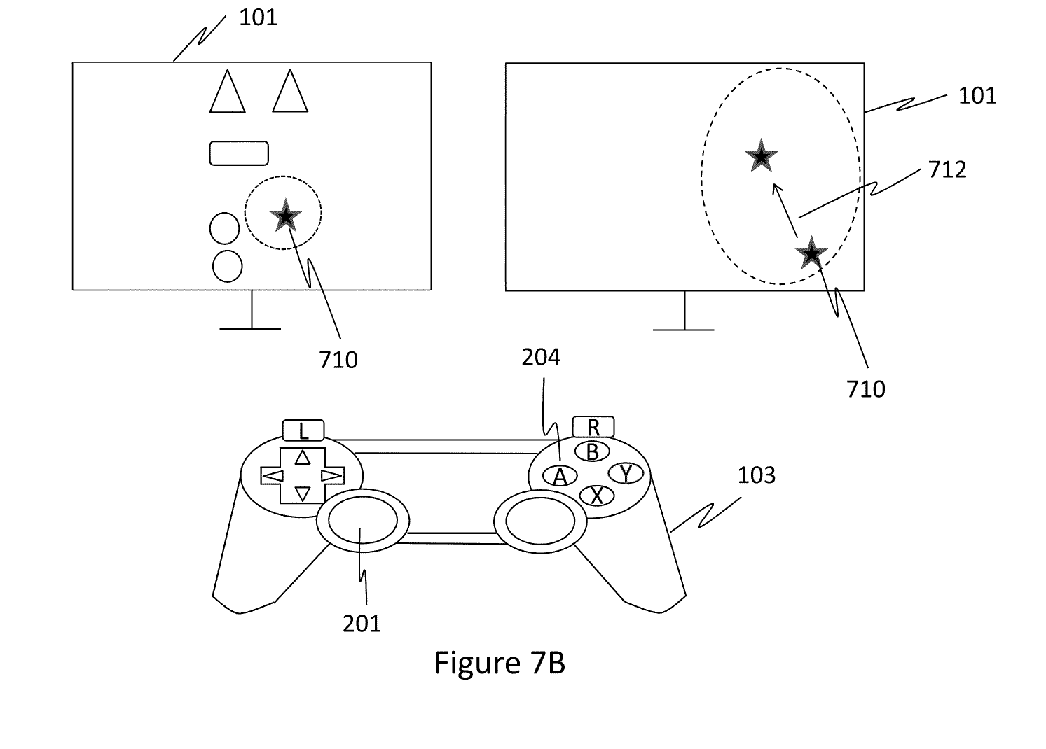

Game D:
Suppose this video game (e.g., firefighting game) requires following inputs from touchscreen and accelerometer:
Touchscreen: Touch to select a hose and drag with swipe to position it.
Accelerometer: Swing the device about certain axis to start water spray from the selected hose.
In order to play this video game using the game controller, exemplary events translation (504, illustrated in FIG. 5) can be:
Insert visual indicator on the screen. Notably, this game requires touch at specific location/region so that correct hose is selected for dragging. When using touchscreen, the player intrinsically knows where touch is applied. However, when using the game controller, it is essential to provide visual feedback to the player about where touch input will be realized. As a result, for this specific game, the present invention introduces a visual indicator on the display to provide feedback to the player about the current position on the screen as understood by the input adaptation module. In a specific embodiment, appearance (e.g., shape, color, brightness, flicker, flash, etc.) of the visual indicator can be changed to indicate that the touch is applied. Additional details on the visual indicator are provided with reference to FIGS. 7A and 7B.
The operation of the left joystick moves this visual indicator on the screen.
Pressing the “green” button generates a touch event understood by the game at the location of the visual indicator. That is, pressing the green button can generate touch-down event at the location of the visual indicator. Releasing the green button can generate touch-up event.
Operating the left joystick while the green button is pressed generates the swipe event to drag the hose as understood by the game. That is, left joystick events generated while the green button is pressed generate one or more touch-move events along the path the visual indicator moves.
Pressing the “red” button generates accelerometer events to indicate swing. For example, pressing the red button can generate two accelerometer events with the first event indicating tilt by 45 degrees about X axis and the second event indicating tilt by -45 degrees about X axis.

As can be seen from these examples, the game controller input events are often required to be mapped to input events from plurality of input devices such as touchscreen and accelerometer in order to enable such video games on the game console. Moreover, the actual mapping needs to differ depending upon the requirements of the game, and hence, static mapping is impractical.

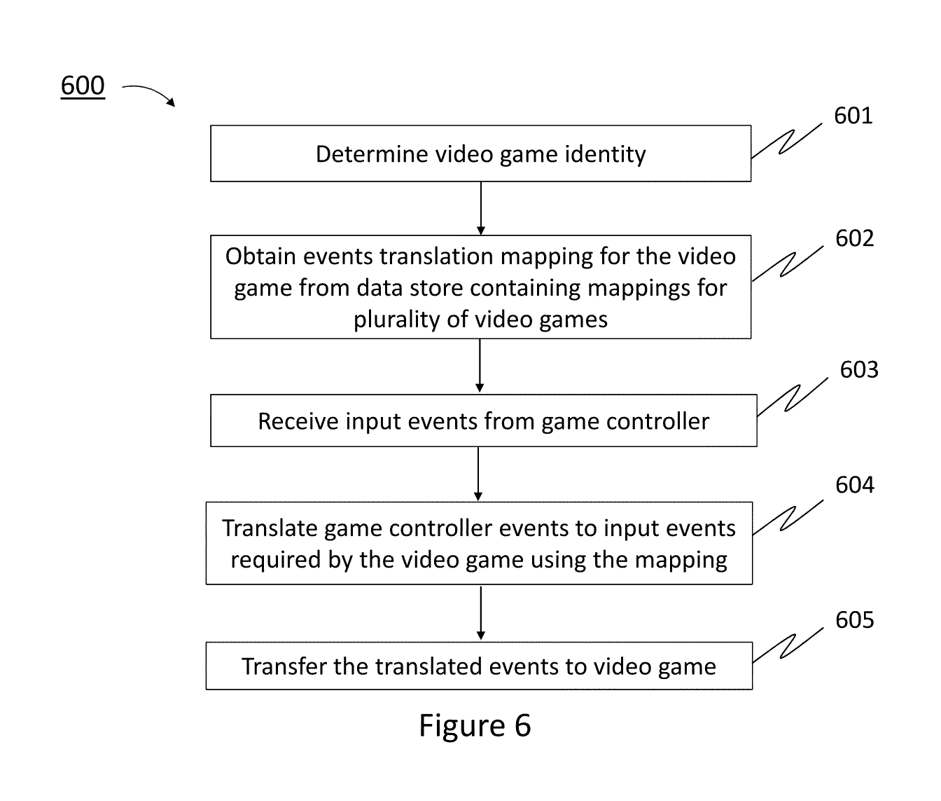

In order to provide seamless end user experience while deploying mobile devices based games on the game console, in a specific embodiment, the present invention contemplates providing a data store that contains events translation mappings (such as in FIG. 5) for a plurality of video games. The data store can be provided entirely or at least in part in the game console. Alternatively, the data store can be provided entirely or at least in part in a computer that is accessible over the computer network such as the Internet. The input adaptation module can automatically identify the video game initiated by the player of the video gaming system, and then without additional user intervention, can obtain the events translation mapping between the game controller events and the input events understood by that video game. An exemplary flowchart for a method (600) for input adaptation according to a specific embodiment of the present invention is illustrated in FIG. 6.

This method can identify (step 601) the video game initiated by the player. For example, the identity can be derived from the file name for the game application and/or certain metadata associated with the game application. As another example, Android applications often have unique package names associated with them. Such unique package name can be used to identify the video game. Notably, the video game can be initiated by the player by browsing a collection of games that are resident on the game console and/or by downloading the game from the Internet, for example, from Android market such as Google Play.

The method can access (step 602) the data store that contains events translation mappings for plurality of video games. In an embodiment, this step can include locally accessing the data store or portion thereof that resides in the game console. In an alternative embodiment, this step can include remotely accessing over a computer network the data store or portion thereof that resides in the remote computer. Based at least upon the identity of the game, the appropriate translation mapping is received from the data store.

The method can receive (step 603) input events from the game controller. These input events are translated (step 604) to the events understood by the video game based upon the events translation mapping received responsive to the accessing the data store. The translated events are transferred to the video game application (step 605) as if they are generated by the input devices that the game requires for operation, such as touchscreen and accelerometer.

In this specific embodiment, the translating step (604) can include certain sub-steps. In the first sub-step, raw events from the game controller are mapped to predetermined set of standard game controller events. In the second sub-step, the standard game controller events are then translated to the input events (touch events, accelerometer events, etc.) that are required by the game application. This two-step translation process permits abstraction of the game controller in the first step. The game controller sends key events when user presses a button or uses joystick. A key event contains key code to indicate which button was pressed. These key codes differ for different game controllers. In order to support various types of game controllers available in the market, the key codes are mapped to standard game controller events which are then translated to the input events required by the game applications, based upon the events translation mapping obtained from the data store.

As discussed before, the events translation table (504) can indicate displaying a visual indicator on the visual output of the video game to provide feedback to the game player about the location of touch when translating game controller input event to touch-based input events. The visual indicator is particularly advantageous when knowing the location of the touch is essential to correctly process the input from the game player. It is also advantageous when knowing path of the swipe (e.g., as identified by start and end points) is essential to correctly process the input from the game player. The visual indicator can be an icon, a shape, etc. As shown in FIG. 7A, when playing a selected video game on mobile device (701) such as smartphone or tablet, the visual output of the video game can be displayed on a touchscreen (702). The video game may require input from the game player by way of touch at a specific location (703) on the touchscreen, for example, touch with player's finger. Alternatively, the video game may require input from the game player by way of swipe (704) along a specific path on the touch screen, for example, swipe with player's finger. According to specific embodiment of the present invention, to facilitate playing this video game using the game controller (103) and a television (101), a visual indicator (710) is displayed on the television. Notably, the television also displays the video game's visual output and as such the visual indicator is visible to the player on the visual output of the video game. The visual indicator can be moved by the player by operation of a control on the game controller such as joystick (201). When the player presses the action button “A” (204), it can be recognized as a touching by the game player at a location of the visual indicator and a touch event can be transferred by the input adaptation module to the video game application. The touch event includes location information of the visual indicator, e.g., X and Y co-ordinates of the visual indicator on the television screen at the time the action button was pressed. Moreover, if the joystick (201) is moved while the action button (204) is pressed, it can be recognized as swiping by the game player along the path of motion of the visual indicator (712). Thus, a swipe event can be transferred by the input adaptation module to the video game application. The swipe event includes information about the start and end points of the swipe, e.g., X and Y co-ordinates of the start and end points. In an embodiment, appearance (e.g., shape, color, emphasis, flicker, etc.) of the visual indicator can be changed when the action button is pressed to provide feedback to game player that the touch is currently in effect.

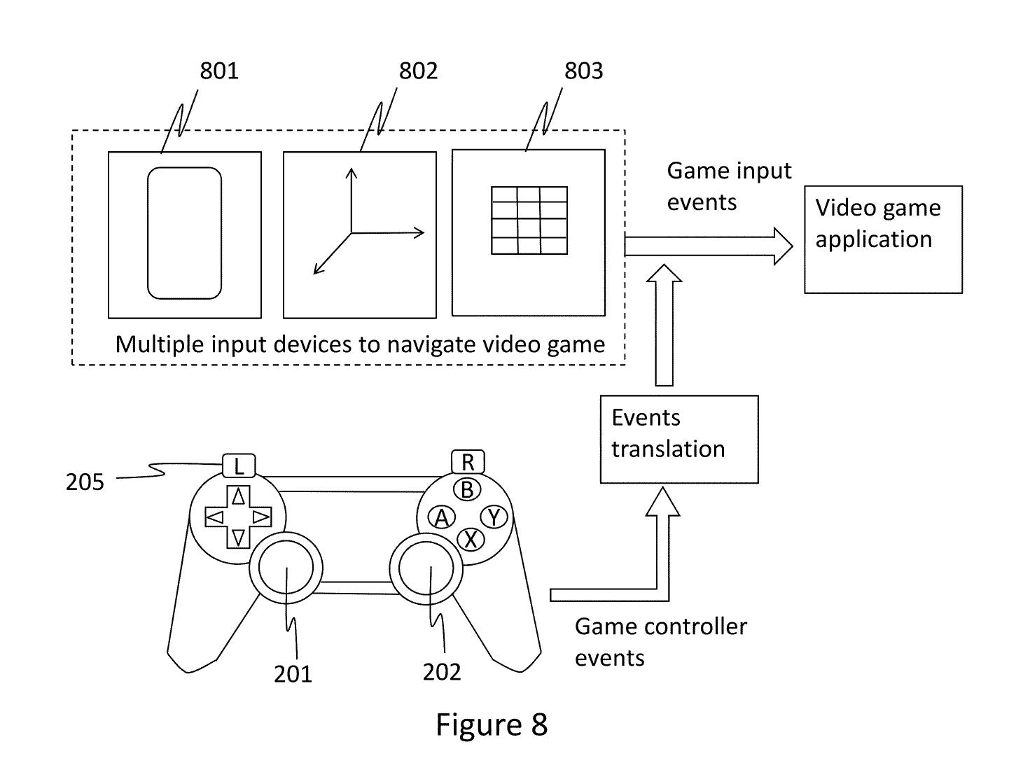

It is to be noted that the present invention can permit playing video games that require use of multiple input devices such as touchscreen and accelerometer in the video gaming system such as illustrated in FIG. 1 using a single game controller. In a specific embodiment, the present invention can map events generated by operation of multiple controls on the game controller to multiple sets of events that can be triggered by multiple input devices, respectively. This is illustrated by exemplary schematic in FIG. 8. As shown in FIG. 8, different controls on the game controller (103) can be mapped to different input devices, for example, left joystick (201) can be mapped to touchscreen (801), right joystick (202) can be mapped to accelerometer (802), left shoulder button (205) can be mapped to a key (803) on the phone, etc. That is, the input adaptation module can include events translation mapping that can translate left joystick events to touchscreen events, right joystick events to accelerometer events, and the left shoulder button events to phone-key events. As can be noted, ability to map game controller events to multiple input devices events facilitates playing many exciting video games using the game controller.

Certain specific embodiments described above illustrate the game controller events mappings. In alternative embodiments, other types of input devices can be used in the video gaming system such as illustrated in FIG. 1. For example, the input device in the video gaming system such as illustrated in FIG. 1 can be a remote control. As merely example, the remote control such as one often found in the airplane personal entertainment system can have direction arrows and action buttons. In this example, the events mapping can be done from the events generated by operation of the remote control such as press/release of direction keys, press/release of action buttons, etc. to the touch and accelerometer based input events understood by the video game application. Such alternative embodiments including different types of input devices in the video gaming system such as illustrated in FIG. 1 will be apparent to person of ordinary skill in the art based on the present disclosure.

Accordingly, the present invention provides system and method for video gaming including a way to enable mobile devices based video games on the console based video gaming system. While specific embodiments have been described, it is to be noted that they are illustrative rather than limiting. Based on the teachings here, person of ordinary skill in the art can contemplate various modifications and alternatives to the illustrated embodiments, wherein one or more components/steps can be added, one or more components/steps can be omitted, one or more components/steps can be implemented in a different manner, one or more components/steps can be split into sub-components/sub-steps, two or more components/steps can be combined, etc. Moreover, various acts according to the present invention can be performed by software, hardware, firmware, or combination thereof. Such modifications and alternatives are included within the scope of the invention.

What is claimed is:

1. A computer system to be coupled to a display device and an input device, and including a way to facilitate video gaming, the system comprising:
a processing unit; and
a computer readable medium coupled to the processing unit and comprising:
a first set of instructions for a video game executable by the processing unit to perform the steps of:
receiving a first input for navigating the video game from a game player, the first input to be provided using multiple input devices including a first input device and a second input device, the first input comprising a first plurality of input events triggered via operation of the first input device and a second plurality of input events triggered via operation of the second input device;
performing game-logic computation for the video game based at least upon the first input; and
generating the video game output based at least upon the performing the game-logic computation; and
a second set of instructions for input adaptation module to facilitate playing the video game using a third input device that is free from facility to provide the first input using the first input device and the second input device, the second set of instructions being executable by the processing unit to perform the steps of:
receiving a second input from a game player provided using the third input device, the second input comprising a third plurality of input events triggered via operation of a first control on the third input device and a fourth plurality of input events triggered via operation of a second control on the third input device;
generating the first plurality of the input events from the third plurality of the input events, based at least upon a first predetermined mapping that translates events triggered by operation of the first control on the third input device to events triggered by operation of the first input device; and
generating the second plurality of the input events from the fourth plurality of the input events, based at least upon a second predetermined mapping that translates events triggered by operation of the second control on the third input device to events triggered by operation of the second input device.

2. The system of claim 1 wherein the first input device is a touchscreen that displays at least a portion of the video game output and the first plurality of the input events include at least two events selected from the group consisting of a touch-down event, a touch-move event and a touch-up event.

3. The system of claim 1 wherein the second input device is an accelerometer and the second plurality of the input events include a plurality of tilt events.

4. The system of claim 1 wherein the third input device is a game controller including one or more joysticks and one or more buttons.

5. The system of claim 4 wherein the first control on the game controller is a first joystick.

6. The system of claim 5 wherein the third plurality of the input events include a plurality of joystick events triggered via operation of the first joystick.

7. The system of claim 5 wherein the second control on the game controller is a second joystick which is different from the first joystick.

8. The system of claim 7 wherein the first joystick is a left joystick and the second joystick is a right joystick.

9. The system of claim 7 wherein the fourth plurality of the input events include a plurality of joystick events triggered via operation of the second joystick.

10. The system of claim 1 wherein the first predetermined mapping and the second predetermined mapping being selected based at least upon identify of the video game.

11. The system of claim 1 wherein the first set of instructions are configured to be incapable to process input events triggered via operation of the third input device.

12. The system of claim 1 wherein the first set of instructions are for the video game that is appropriate to be played on a mobile device equipped with the first input device and the second input device.

13. The system of claim 1 wherein the first set of instructions for the first video game and the second set of instructions for the input adaptation module are executable in an Android operating system environment.

14. A method to facilitate video gaming, the method comprising:
initiating a video game application on a computer system coupled to a display device and a third input device, wherein the video game application is programmed to:
receive a first input for navigating the video game from a game player, the first input to be provided using multiple input devices including a first input device and a second input device, the first input comprising a first plurality of input events triggered via operation of the first input device and a second plurality of input events triggered via operation of the second input device,
perform game-logic computation for the video game based at least upon the first input, and
display the video game output on the display device based at least upon the performing the game-logic computation; and
performing input adaptation to facilitate playing the video game using the third input device that is free from facility to provide the first input using the first input device and the second input device by:
receiving a second input from a game player provided using the third input device, the second input comprising a third plurality of input events triggered via operation of a first control on the third input device and a fourth plurality of input events triggered via operation of a second control on the third input device;
generating the first plurality of the input events from the third plurality of the input events, based at least upon a first predetermined mapping that translates events triggered by operation of the first control on the third input device to events triggered by operation of the first input device; and
generating the second plurality of the input events from the fourth plurality of the input events, based at least upon a second predetermined mapping that translates events triggered by operation of the second control on the third input device to events triggered by operation of the second input device.

15. The method of claim 14 wherein the first input device is a touchscreen that displays at least a portion of the video game output and the first plurality of the input events include at least two events selected from the group consisting of a touch-down event, a touch-move event and a touch-up event.

16. The method of claim 14 wherein the second input device is an accelerometer and the second plurality of the input events include a plurality of tilt events.

17. The method of claim 14 wherein the third input device is a game controller including one or more joysticks and one or more buttons.

18. The method of claim 17 wherein the first control on the game controller is a first joystick.

19. The method of claim 18 wherein the second control on the game controller is a second joystick which is different from the first joystick.

20. The method of claim 18 wherein the second control on the game controller is a button.
